(19) United States
(12) Patent Application Publication
(10) Pub. No.: US 2023/0139779 A1
(43) Pub. Date: May 4, 2023

(54) COMBUSTION DEVICE

(71) Applicant: Rinnai Corporation, Nagoya-shi (JP)

(72) Inventor: Ryosuke YUGE, Nagoya-shi (JP)

(73) Assignee: Rinnai Corporation, Nagoya-shi (JP)

(21) Appl. No.: 18/051,672

(22) Filed: Nov. 1, 2022

(30) Foreign Application Priority Data
Nov. 2, 2021 (JP) 2021179367

(51) Int. Cl. F24D 19/08

(52) U.S. Cl. CPC F24D 19/088

(57) ABSTRACT

A combustion device may include a casing including a bottom plate, a combustion unit housed in the casing, and a fan housed in the casing and configured to take in air inside the casing and supply the air to the combustion unit. The bottom plate may be provided with a flat portion and a recess recessed downward from the flat portion. The recess may be provided with a drainage hole and an eave arranged above the drainage hole. The drainage hole may be located below an upper surface of the flat portion. The eave may be at least partially located below the upper surface of the flat portion.

### CROSS-REFERENCE TO RELATED APPLICATION

This application claims priority to Japanese Patent Application No. 2021-179367, filed on Nov. 2, 2021, the entire contents of which are incorporated herein by reference.

### TECHNICAL FIELD

The disclosure herein relates to combustion devices.

### BACKGROUND

Japanese Patent Application No. 2018-84379 describes a combustion device including a casing having a bottom plate, a combustion unit housed in the casing, and a fan housed in the casing and configured to take in air inside the casing and supply the air to the combustion unit. The bottom plate is provided with a flat portion and a recess recessed downward from the flat portion. The recess is provided with a drainage hole. The drainage hole is located below an upper surface of the flat portion.

### SUMMARY

In combustion devices including a fan configured to take in air inside a casing, such as the one described in Japanese Patent Application No. 2018-84379, rainwater, etc. may be suctioned into the casing through the drainage hole due to a negative pressure generated by the fan. In this instance, the rainwater, etc. suctioned through the drainage hole may spatter and adhere to components in the casing. The disclosure herein provides a technology that suppresses rainwater, etc. suctioned through a drainage hole from adhering to components in a casing in a combustion device comprising a fan configured to take in air inside the casing.

A combustion device disclosed herein may comprise a casing comprising a bottom plate, a combustion unit housed in the casing, and a fan housed in the casing and configured to take in air inside the casing and supply the air to the combustion unit. The bottom plate may be provided with a flat portion and a recess recessed downward from the flat portion. The recess may be provided with a drainage hole and an eave arranged above the drainage hole. The drainage hole may be located below an upper surface of the flat portion. The eave may be at least partially located below the upper surface of the flat portion.

Since the drainage hole is provided in the bottom plate of the casing, most of components in the casing are typically located above the drainage hole. Thus, when rainwater, etc. suctioned through the drainage hole spatters upward, the rainwater, etc. may adhere to the components in the casing. According to the configuration above, the eave is arranged above the drainage hole. Thus, even when the rainwater, etc. is suctioned into the casing through the drainage hole, the eave suppresses the rainwater, etc. from spattering upward from the drainage hole. The configuration above can thus suppress the rainwater, etc. suctioned through the drainage hole from adhering to the components in the casing in the combustion device comprising the fan configured to take in air inside the casing. Locating the entirety of such an eave above the upper surface of the flat portion requires a size of the casing to be increased in order to avoid interference of the eave with the components in the casing. According to the configuration above, the eave is at least partially located below the upper surface of the flat portion, and thus the size of the casing can be reduced as compared with a configuration in which the entirety of the eave is located above the upper surface of the flat portion.

In one or more embodiments, the drainage hole and the eave may be formed by cutting a part of the recess and bending the part inward. In the disclosure herein, “inside/inward” means the inside of the casing/toward the inside of the casing, and “outside/outward” means the outside of the casing/toward the outside of the casing.

For example, if the drainage hole and the eave are formed separately in the casing, this may result in an increase in manufacturing cost of the casing. According to the configuration above, the drainage hole and the eave can be formed simultaneously by cutting a part of the bottom plate of the casing and bending the part. The configuration above can reduce the manufacturing cost of the casing including the drainage hole and the eave.

In one or more embodiments, the drainage hole and the eave may be formed by cutting a part of the recess and performing inward drawing to the part.

According to the configuration above, the drainage hole and the eave can be formed simultaneously by cutting a part of the bottom plate of the casing and performing drawing to the part, and thus manufacturing cost of the casing including the drainage hole and the eave can be reduced. Further, according to the configuration above, an inflow direction of air through the drainage hole is rectified to a direction along the bottom plate by the eave formed as above. According to the configuration above, rainwater, etc. suctioned into the casing through the drainage hole is likely to be guided in the direction along the bottom plate, and thus upward spattering of the rainwater, etc. from the drainage hole can be suppressed more effectively.

In one or more embodiments, the recess may comprise a first plate inclined with respect to the flat portion. The drainage hole may be defined in the first plate.

According to the configuration above, rainwater, etc. is suctioned into the casing through the drainage hole in a direction inclined with respect to an up-direction. Thus, upward spattering of the rainwater, etc. from the drainage hole can be suppressed more effectively. The configuration above can more effectively suppress the rainwater, etc. suctioned through the drainage hole from adhering to the components in the casing in the combustion device comprising the fan configured to take in air inside the casing.

In one or more embodiments, the eave may be connected to an upper portion of a peripheral edge of the drainage hole.

According to the configuration above, when rainwater, etc. is suctioned into the casing through the drainage hole, the eave can more suitably suppress upward spattering of the rainwater, etc. from the drainage hole. The configuration above can thus more effectively suppress the rainwater, etc. suctioned through the drainage hole from adhering to the components in the casing in the combustion device comprising the fan configured to take in air inside the casing.

In one or more embodiments, the recess may further comprise a second plate that is inclined with respect to the flat portion and arranged to face the first plate in a direction along the flat portion.

According to the configuration above, when rainwater, etc. is suctioned into the casing through the drainage hole, upward spattering of the rainwater, etc. from the drainage hole can be suppressed by the eave and also spattering of the rainwater, etc. in the direction along the flat portion can be suppressed by the second plate. The configuration above can thus more effectively suppress the rainwater, etc. suctioned through the drainage hole from adhering to the components in the casing in the combustion device comprising the fan configured to take in air inside the casing.

### BRIEF DESCRIPTION OF DRAWINGS

FIG. 1 is a perspective view of the entire water heater 2 according to an embodiment, as viewed from the upper front left side.

FIG. 2 is a perspective view of the entire water heater 2 according to the embodiment, as viewed from the lower rear right side.

FIG. 3 is a diagram illustrating components housed in a casing 10 of the water heater 2 according to the embodiment.

FIG. 4 is a perspective view of a bottom plate 20 constituting the casing 10 of the water heater 2 according to the embodiment, as viewed from the upper front left side.

FIG. 5 is a perspective view of a first recess 240a provided in the bottom plate 20 constituting the casing 10 of the water heater 2 according to the embodiment, as viewed from the upper rear left side.

FIG. 6 is a diagram illustrating the first recess 240a provided in the bottom plate 20 constituting the casing 10 of the water heater 2 according to the embodiment, as viewed from below.

FIG. 7 is a cross-sectional view of the first recess 240a provided in the bottom plate 20 constituting the casing 10 of the water heater 2 according to the embodiment, taken along a line D-D in FIG. 6.

FIG. 8 is a perspective view of a drainage hole 282a and an eave 284a provided in a first plate 242a of a first recess 240a of a water heater 2 according to a variant, as viewed from the upper front left side.

### DETAILED DESCRIPTION

### Embodiments

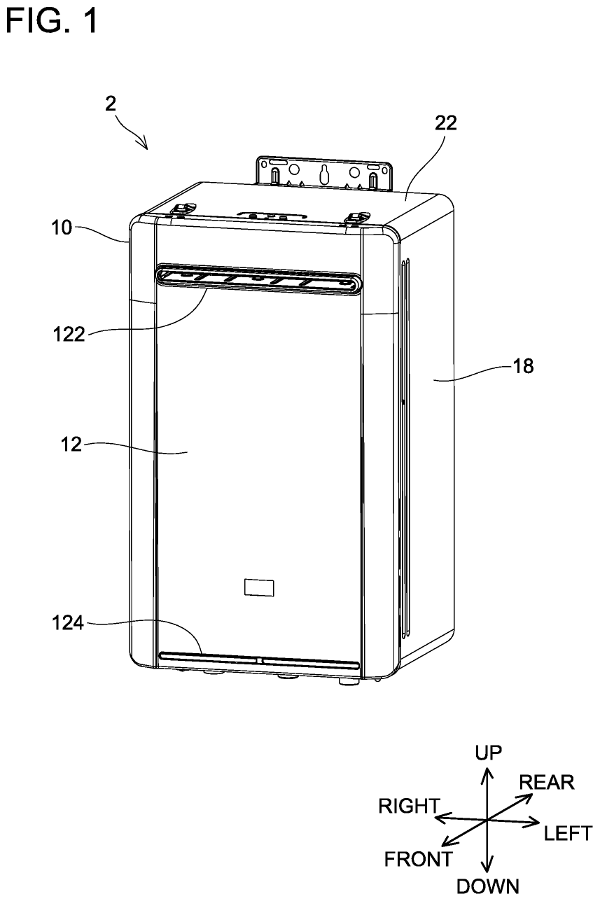

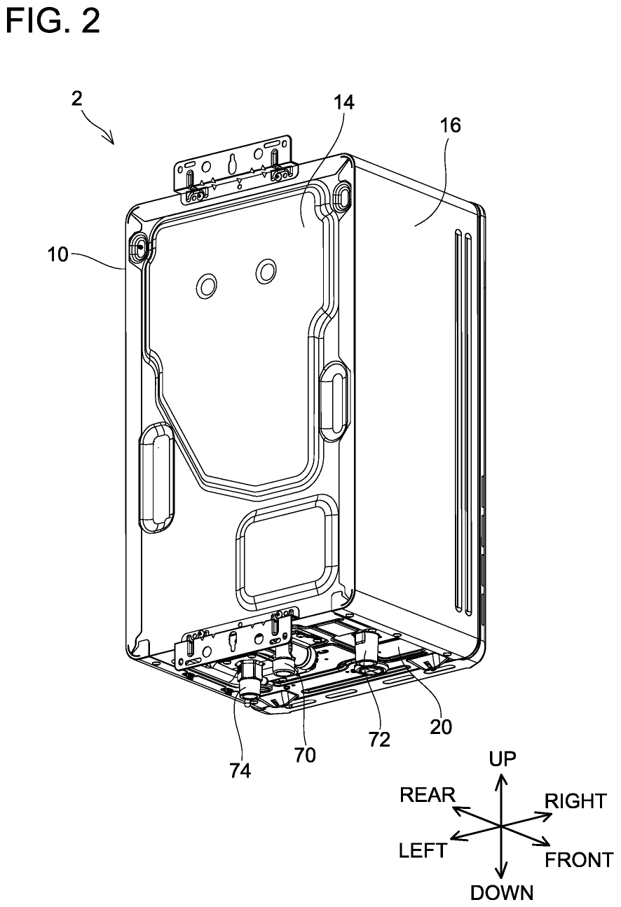

A water heater 2 according to an embodiment illustrated in FIG. 1 is placed outdoors for use. The water heater 2 comprises a casing 10. The casing 10 comprises a front plate 12, a rear plate 14 (see FIG. 2), a right plate 16 (see FIG. 2), a left plate 18, a bottom plate 20 (see FIG. 2), and a top plate 22. The right plate 16, the left plate 18, and the top plate 22 are integral with each other. An exhaust outlet 122 for discharging exhaust gas generated in a combustion unit 50, which will be described later, is provided in an upper portion of the front plate 12. An air inlet 124 for taking outside air into the casing 10 is provided in a lower portion of the front plate 12.

As illustrated in FIG. 2, the rear plate 14 and the bottom plate 20 are integrated with each other. Attached to the bottom plate 20 are a water supply connecting port 70 for connection of a water supply means for water supply to the water heater 2, a hot water supply connecting port 72 for connection of a hot water supply means for hot water supply from the water heater 2, and a gas supply connecting port 74 for connection of a gas supply means for fuel gas supply to the water heater 2.

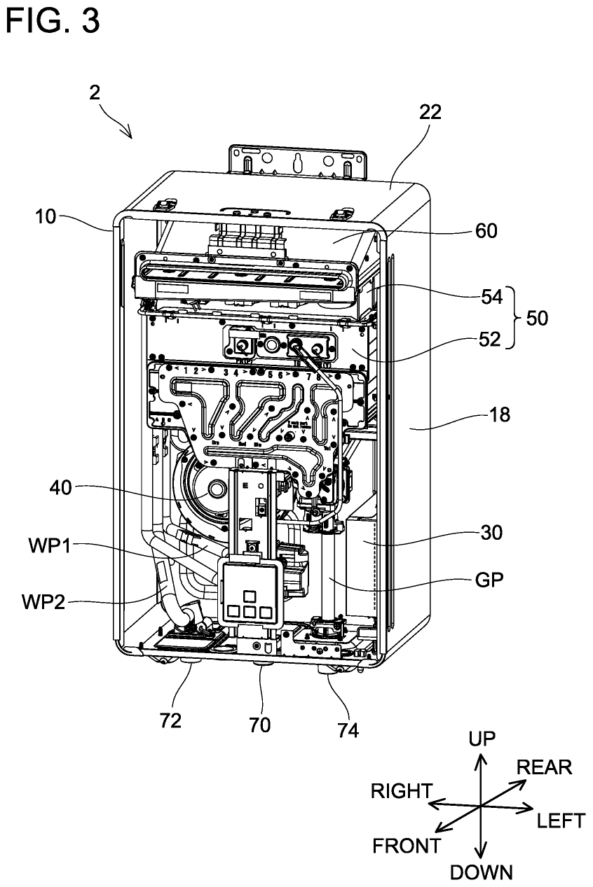

As illustrated in FIG. 3, the casing 10 houses a controller 30, a fan 40, the combustion unit 50, an exhaust duct 60, a water supply pipe WP1, a hot water supply pipe WP2, and a gas supply pipe GP.

The controller 30 is attached to the left plate 18 in a lower portion of the casing 10. The controller 30 controls operations of the fan 40, the combustion unit 50, and other components of the water heater 2.

The fan 40 is located in a central portion of the casing 10. The fan 40 includes an air intake (not illustrated) that is open inside the casing 10. The fan 40 is connected to the combustion unit 50. While the fan 40 is in operation, air inside the casing 10 is taken into the air intake of the fan 40 and supplied to the combustion unit 50.

The combustion unit 50 is located above the fan 40. The combustion unit 50 comprises a gas burner 52 and a heat exchanger 54. In the combustion unit 50, the heat exchanger 54 is located above the gas burner 52. The gas burner 52 is connected to the gas supply connecting port 74 via the gas supply pipe GP. The gas burner 52 combusts fuel gas supplied through the gas supply pipe GP by using the air supplied from the fan 40, thereby generating combustion gas. The heat exchanger 54 heats water flowing through a water pipe (not illustrated) in the heat exchanger 54 by the combustion gas generated by the combustion in the gas burner 52. One end of the water pipe in the heat exchanger 54 is connected to the water supply connecting port 70 via the water supply pipe WP1. The other end of the water pipe in the heat exchanger 54 is connected to the hot water supply connecting port 72 via the hot water supply pipe WP2. Thus, water supplied to the water heater 2 is heated by the heat exchanger 54 and is then supplied as hot water.

The exhaust duct 60 is located above the combustion unit 50. The exhaust duct 60 is connected to the exhaust outlet 122 of the front plate 12 (see FIG. 1) and discharges the combustion gas generated in the combustion unit 50. That is, the combustion gas in the gas burner 52 passes the heat exchanger 54 and is discharged to the outside from the exhaust duct 60.

### Configuration of Bottom Plate 20

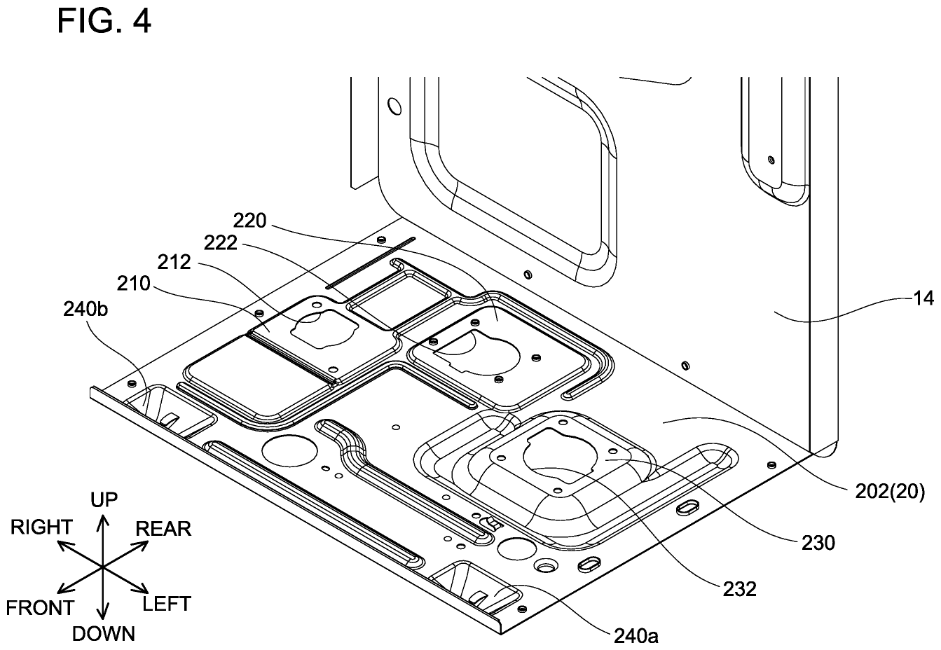

As illustrated in FIG. 4, the bottom plate 20 comprises a flat portion 202, a first projection 210, a second projection 220, a third projection 230, a first recess 240a, and a second recess 240b. The flat portion 202 has a plate shape expanding in an up-down direction and a right-left direction. The first projection 210, the second projection 220, and the third projection 230 project upward from the flat portion 202. The first projection 210 includes a first mounting hole 212 for attachment of the hot water supply connecting port 72. The second projection 220 includes a second mounting hole 222 for attachment of the water supply connecting port 70. The third projection 230 includes a third mounting hole 232 for attachment of the gas supply connecting port 74. The hot water supply connecting port 72 is attached such that it seals an interspace between the hot water supply connecting port 72 and the first mounting hole 212. The water supply connecting port 70 is attached such that it seals an interspace between the water supply connecting port 70 and the second mounting hole 222. The gas supply connecting port 74 is attached such that it seals an interspace between the gas supply connecting port 74 and the third mounting hole 232. Thus, rainwater, etc. is prevented from entering the inside of the casing 10 through the first mounting hole 212, the second mounting hole 222, and the third mounting hole 232.

The first recess 240a is provided in a front left portion of the bottom plate 20. The second recess 240b is provided in a front right portion of the bottom plate 20. The first recess 240a and the second recess 240b are recessed downward with respect to the flat portion 202. Thus, rainwater, etc. that entered the casing 10 is guided to the first recess 240a and/or the second recess 240b. In the present embodiment, the first recess 240a and the second recess 240b have mirror symmetry shapes. Thus, it should be understood that the following description on the first recess 240a can be applied to the second recess 240b.

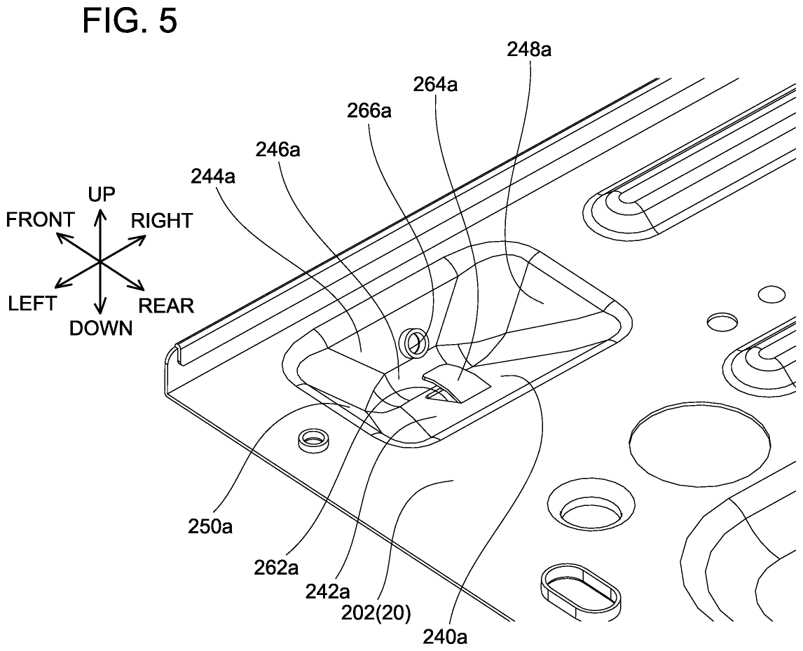

As illustrated in FIG. 5, the first recess 240a comprises a first plate 242a, a second plate 244a, a first connecting portion 246a, a second connecting portion 248a, and a third connecting portion 250a. The first plate 242a is located in a rear portion of the first recess 240a. The second plate 244a is located in a front portion of the first recess 240a. The first plate 242a and the second plate 244a are arranged to face each other in a front-rear direction. The first connecting portion 246a smoothly connects a lower end of the first plate 242a to a lower end of the second plate 244a. The second connecting portion 248a smoothly connects a right end of the first plate 242a to a right end of the second plate 244a. The third connecting portion 250a smoothly connects a left end of the first plate 242a to a left end of the second plate 244a. A drainage hole 262a and an eave 264a are provided at the first plate 242a. The drainage hole 262a and the eave 264a are formed by cutting a part of the first plate 242a and bending the part inward (which may be termed “cut-bend process” hereinafter). An extruded tap hole 266a is provided in the second plate 244a.

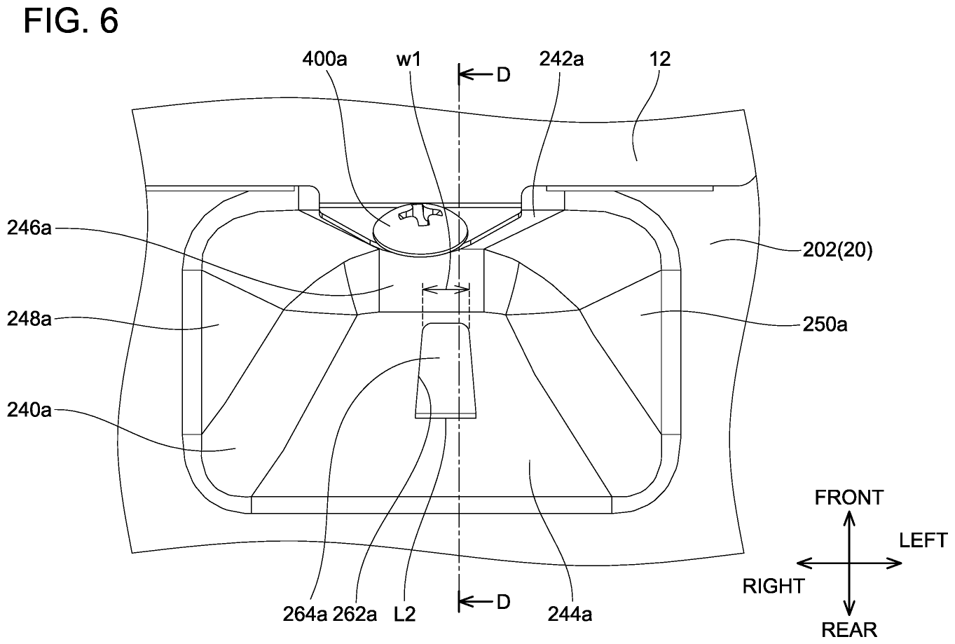

As illustrated in FIG. 6, the bottom plate 20 and the front plate 12 are coupled to each other with a screw member 400a. The screw member 400a couples the bottom plate 20 to the front plate 12 by being screwed in the extruded tap hole 266a (see FIG. 5) from the outside. The centers of the drainage hole 262a and the eave 264a in the right-left direction are offset leftward with respect to the centers of the extruded tap hole 266a and the screw member 400a in the right-left direction. A folding line L2 on the first plate 242a in the cut-bend process is along the right-left direction. The cut-bend process is performed such that a part of the first plate 242a that is located forward of the folding line L2 is cut and bent. The drainage hole 262a has a trapezoidal shape that is symmetrical in the right-left direction. A width of the drainage hole 262a in the right-left direction is decreased forward. In the present embodiment, a length of the folding line L2 in the right-left direction is 6 mm. A width w1 of a front portion of the drainage hole 262a in the right-left direction is 4 mm.

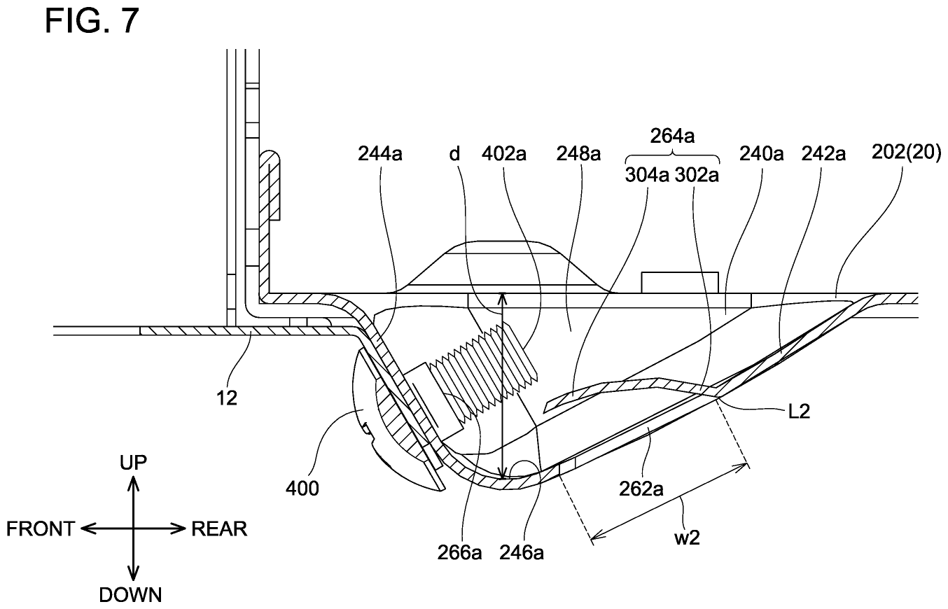

As illustrated in FIG. 7, the first plate 242a is inclined downward and forward with respect to the flat portion 202, substantially at a constant inclination angle. The inclination angle of the first plate 242a with respect to the flat portion 202 is in a range from 30 degrees to 45 degrees. The second plate 244a is inclined downward and rearward with respect to the flat portion 202, substantially at a constant inclination angle. The inclination angle of the second plate 244a with respect to the flat portion 202 is in a range from 60 degrees to 70 degrees. The first connecting portion 246a is curved such that a central portion of the first connecting portion 246a is below an end portion thereof.

The entirety of the drainage hole 262a and the entirety of the eave 264a are located below an upper surface of the flat portion 202. The drainage hole 262a extends downward and forward from a base end portion 302a of the eave 264a. That is, the base end portion 302a of the eave 264a is connected to an upper rear portion of a peripheral edge of the drainage hole 262a. A bending angle of the base end portion 302a with respect to the first plate 242a at the folding line L2 is in a range from 20 degrees to 60 degrees. The eave 264a is curved such that parts of the eave 264a that are closer to a distal end portion 304a have smaller inclination angles with respect to the first plate 242a. The distal end portion 304a of the eave 264a extends forward beyond a lower front portion of the peripheral edge of the drainage hole 262a. In the present embodiment, a width w2 of the drainage hole 262a in the inclination direction of the first plate 242a is 10 mm. The maximum depth d of the first recess 240a in the up-down direction is 10 mm.

In the water heater 2 according to the present embodiment, rainwater, etc. may be suctioned into the inside through the drainage hole 262a due to a negative pressure generated by the fan 40 in the casing 10. In this instance, although the rainwater, etc. flows in fast through the drainage hole 262a due to the negative pressure, the upward momentum of the rainwater, etc. is reduced by the eave 264a expanding in the front-rear direction and the right-left direction above the drainage hole 262a. Further, since the base end portion 302a of the eave 264a is sufficiently bent with respect to the first plate 242a, the eave 264a does not prevent the rainwater, etc. from flowing out through the drainage hole 262a. As above, the eave 264a suppresses upward spattering of rainwater, etc. suctioned through the drainage hole 262a, while maintaining the drainage performance of the drainage hole 262a.

The screw member 400a couples the front plate 12 to the bottom plate 20 by being screwed in the extruded tap hole 266a with the screw member 400a inserted in a hole (not illustrated) provided in the front plate 12. In the state where the screw member 400a is screwed in the extruded tap hole 266a, a tip 402a of the screw member 400a is located below the upper surface of the flat portion 202.

With such a screw member 400a, if the tip 402a of the screw member 400a is located above the upper surface of the flat portion 202, an increased size of the casing 10 is required to avoid interference of the screw member 400a with the components in the casing 10. In the present embodiment, the tip 402a of the screw member 400a is located below the upper surface of the flat portion 202. Thus, the size of the casing 10 is reduced as compared with a configuration in which the tip 402a is located above the upper surface of the flat portion 202.

### Variants

In the embodiment above, the water heater 2, which heats water supplied from an external and supplies the resulting hot water, is described as an example of combustion device. In another embodiment, the combustion device may be another combustion device other than the water heater 2. For example, the combustion device may be a heating device that heats and circulates heating water, or the like. For example, the heating water may be antifreeze liquid.

In the embodiment above, the fan 40 is located in the central portion of the casing 10. Unlike this, the fan 40 may not be located in the central portion of the casing 10. For example, the fan 40 may be located in an upper portion or the lower portion of the casing 10.

In the embodiment above, the fan 40 is connected to the combustion unit 50, and air inside the casing 10 is taken into the air intake of the fan 40 and supplied to the combustion unit 50 while the fan 40 is in operation. In another embodiment, the fan 40 may be located between the combustion unit 50 and the exhaust duct 60 and connected to each of the combustion unit 50 and the exhaust duct 60. In this instance, the combustion unit 50 may include an air intake. In this instance, while the fan 40 is in operation, the air inside the casing 10 may be taken into the air intake of the combustion unit 50 and the combustion gas from the combustion unit 50 may flow through the fan 40 and the exhaust duct 60 and be discharged from the exhaust outlet 122 of the front plate 12 to the outside of the water heater 2.

In the embodiment above, the first recess 240a is provided in a front portion of the bottom plate 20, the first recess 240a includes the extruded tap hole 266a, and the front plate 12 is coupled to the first recess 240a of the bottom plate 20 by the screw member 400a being screwed in the extruded tap hole 266a. Unlike this, the first recess 240a may not be provided in the front portion of the bottom plate 20. For example, the first recess 240a may be provided in a rear portion of the bottom plate 20. The first recess 240a may not include the extruded tap hole 266a. In this instance, the front plate 12 may be coupled to a portion of the bottom plate 20 other than the first recess 240a.

In the embodiment above, regarding the first plate 242a, the entirety of the eave 264a is located below the upper surface of the flat portion 202. In another embodiment, a part of the eave 264a may be located above the upper surface of the flat portion 202 and the remaining part of the eave 264a may be located below the upper surface of the flat portion 202.

In the embodiment above, the drainage hole 262a and the eave 264a are provided at the first plate 242a. In another embodiment, the drainage hole 262a and the eave 264a may be provided at the second plate 244a. In yet another embodiment, the first recess 240a may comprise a flat portion connecting the lower end of the first plate 242a to the lower end of the second plate 244a instead of the first connecting portion 246a, and the drainage hole 262a and the eave 264a may be provided at the flat portion of the first recess 240a.

In the embodiment above, the folding line L2 of the cut-bend process is along the right-left direction and the cut-bend process is performed such that the portion located forward of the folding line L2 is cut and bent. Unlike this, the folding line L2 of the cut-bend process may not be along the right-left direction and the cut-bend process may not be performed such that the portion located forward of the folding line L2 is cut and bent. For example, the folding line L2 of the cut-bend process may be along the front-rear direction and the cut-bend process may be performed such that a portion located leftward of the folding line L2 is cut and bent.

In the embodiment above, the drainage hole 262a and the eave 264a are formed by performing the cut-bend process to the first plate 242a. In another embodiment, the drainage hole 262a and the eave 264a may be formed separately. For example, the drainage hole 262a may be formed by performing punching to the first plate 242a, and the eave 264a, which was formed as a separate component, may be welded to the peripheral edge of the drainage hole 262a.

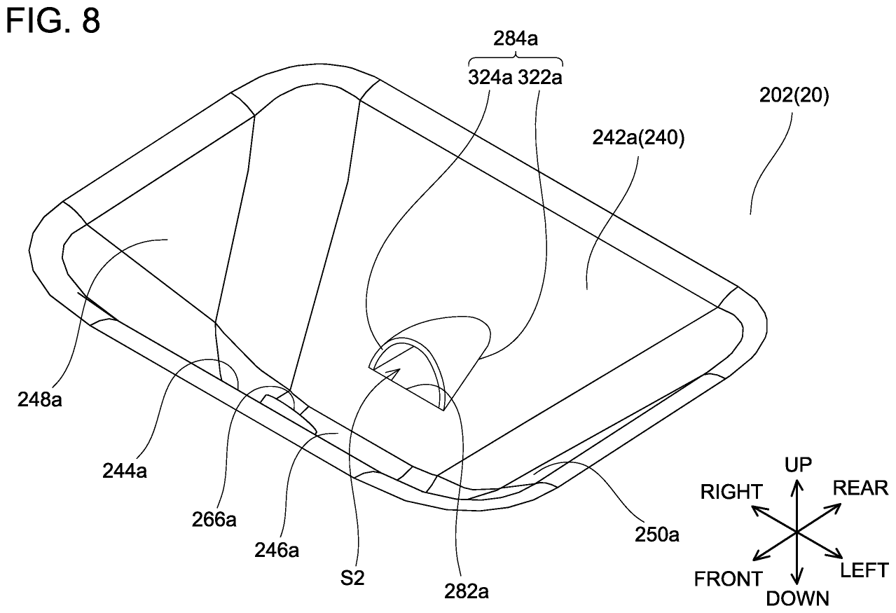

In yet another embodiment, as illustrated in FIG. 8, a drainage hole 282a and an eave 284a may be provided at the first plate 242a instead of the drainage hole 262a and the eave 264a. The drainage hole 282a and the eave 284a may be formed by cutting a part of the first plate 242a and performing inward drawing to the part (which may be termed “cut-drawing process” hereinafter). The eave 284a has a shape formed by drawing. An opening S2 is defined by a portion of a peripheral edge of the drainage hole 282a that is not connected to a base end portion 322a of the eave 284a and a distal end portion 324a of the eave 284a. The opening S2 is open in a direction along the first plate 242a. Thus, an inflow direction of air through the drainage hole 282a is rectified to the direction along the first plate 242a by the eave 284a. Accordingly, even when rainwater, etc. is suctioned to the inside through the drainage hole 282a due to the negative pressure generated by the fan 40 in the casing 10, the rainwater, etc. is guided downward along the first plate 242a, and thus upward spattering of the rainwater, etc. from the drainage hole 282a can be suppressed.

### Corresponding Relationships

As described, in one or more embodiments, the water heater 2 (an example of combustion device) comprises the casing 10 comprising the bottom plate 20, the combustion unit 50 housed in the casing 10, and the fan 40 housed in the casing 10 and configured to take in air inside the casing 10 and supply the air to the combustion unit 50. The bottom plate 20 is provided with the flat portion 202 and the first recess 240a recessed downward from the flat portion 202. The first recess 240a is provided with the drainage hole 262a (or the drainage hole 282a) and the eave 264a (or the eave 284a) arranged above the drainage hole 262a (or the drainage hole 282a). The drainage hole 262a (or the drainage hole 282a) is located below the upper surface of the flat portion 202. The eave 264a (or the eave 284a) is at least partially located below the upper surface of the flat portion 202.

Since the drainage hole 262a (or the drainage hole 282a) is typically provided in the bottom plate 20 of the casing 10, most of components in the casing 10, such as the controller 30, the fan 40, the combustion unit 50, the exhaust duct 60, the water supply pipe WP1, the hot water supply pipe WP2, and the gas supply pipe GP, are located above the drainage hole 262a (or the drainage hole 282a). According to the configuration above, the eave 264a (or the eave 284a) is arranged above the drainage hole 262a (or the drainage hole 282a). Thus, even when rainwater, etc. is suctioned into the casing 10 through the drainage hole 262a (or the drainage hole 282a), the eave 264a (or the eave 284a) suppresses the rainwater, etc. from spattering upward from the drainage hole 262a (or the drainage hole 282a). The configuration above can suppress the rainwater, etc. suctioned through the drainage hole 262a (or the drainage hole 282a) from adhering to the components in the casing 10 in the water heater 2 comprising the fan 40 configured to take in air inside the casing 10. For the arrangement of such an eave 264a (or the eave 284a), locating the entirety of the eave 264a (or the eave 284a) above the upper surface of the flat portion 202 requires an increased size of the casing 10 to avoid interference of the eave 264a (or the eave 284a) with the components in the casing 10. According to the configuration above, the eave 264a (or the eave 284a) is at least partially located below the upper surface of the flat portion 202, and thus the size of the casing 10 can be reduced as compared with a configuration in which the entirety of the eave 264a (or the eave 284a) is located above the upper surface of the flat portion 202.

In one or more embodiments, the drainage hole 262a and the eave 264a are formed by cutting a part of the first recess 240a and bending the part inward (i.e., by the cut-bend process).

For example, if the drainage hole 262a and the eave 264a are formed separately in the casing 10, this may result in an increase in manufacturing cost of the casing 10. According to the configuration above, the drainage hole 262a and the eave 264a can be formed simultaneously by performing the cut-bend process to the bottom plate 20 of the casing 10. The configuration above can reduce the manufacturing cost of the casing 10 including the drainage hole 262a and the eave 264a.

In one or more embodiments, the drainage hole 282a and the eave 284a are formed by cutting a part of the first recess 240a and performing inward drawing to the part (i.e., by the cut-drawing process).

According to the configuration above, the drainage hole 282a and the eave 284a can be formed simultaneously by performing the cut-drawing process to the bottom plate 20 of the casing 10, and thus the configuration can reduce the manufacturing cost of the casing 10 including the drainage hole 282a and the eave 284a. Further, according to the configuration above, the inflow direction of air through the drainage hole 282a is rectified to the direction along the first plate 242a (an example of bottom plate) by the eave 284a formed by the cut-drawing process. According to the configuration above, rainwater, etc. suctioned into the casing 10 through the drainage hole 282a is likely to be guided in the direction along the first plate 242a, and thus upward spattering of the rainwater, etc. from the drainage hole 282a can be suppressed more effectively. The configuration above can thus more effectively suppress the rainwater, etc. suctioned through the drainage hole 282a from adhering to the components within the casing 10 in the water heater 2 comprising the fan 40 configured to take in air inside the casing 10.

In one or more embodiments, the first recess 240a comprises the first plate 242a inclined with respect to the flat portion 202. The drainage hole 262a (or the drainage hole 282a) is provided in the first plate 242a.

According to the configuration above, rainwater, etc. is suctioned into the casing 10 through the drainage hole 262a (or the drainage hole 282a) in a direction inclined with respect to an up-direction. Thus, upward spattering of the rainwater, etc. from the drainage hole 262a (or the drainage hole 282a) can be suppressed more effectively. The configuration above can thus more effectively suppress the rainwater, etc. suctioned through the drainage hole 262a (or the drainage hole 282a) from adhering to the components in the casing 10 in the water heater 2 comprising the fan 40 configured to take in air inside the casing 10.

In one or more embodiments, the eave 264a (or the eave 284a) is connected to the upper portion of the peripheral edge of the drainage hole 262a (or the drainage hole 282a).

According to the configuration above, when rainwater, etc. is suctioned into the casing 10 through the drainage hole 262a (or the drainage hole 282a), the eave 264a (or the eave 284a) can more effectively suppress upward spattering of the rainwater, etc. from the drainage hole 262a (or the drainage hole 282a). The configuration above can thus more effectively suppress the rainwater, etc. suctioned through the drainage hole 262a (or the drainage hole 282a) from adhering to the components in the casing 10 in the water heater 2 comprising the fan 40 configured to take in air inside the casing 10.

In one or more embodiments, the first recess 240a further comprises the second plate 244a that is inclined with respect to the flat portion 202 and arranged to face the first plate 242a in the direction along the flat portion 202.

According to the configuration above, when rainwater, etc. is suctioned into the casing 10 through the drainage hole 262a (or the drainage hole 282a), upward spattering of the rainwater, etc. from the drainage hole 262a (or the drainage hole 282a) can be suppressed by the eave 264a (or the eave 284a) and also spattering of the rainwater, etc. in the direction along the flat portion 202 can be suppressed by the second plate 244a. The configuration above can more effectively suppress the rainwater, etc. suctioned through the drainage hole 262a (or the drainage hole 282a) from adhering to the components within the casing 10 in the water heater 2 comprising the fan 40 configured to take in air inside the casing 10.

Specific examples of the present invention have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the art described in the description and the drawings may concurrently achieve a plurality of aims, and technical significance thereof resides in achieving any one of such aims.

What is claimed is:

1. A combustion device comprising:
a casing comprising a bottom plate;
a combustion unit housed in the casing; and
a fan housed in the casing and configured to take in air inside the casing and supply the air to the combustion unit,
wherein
the bottom plate is provided with a flat portion and a recess recessed downward from the flat portion,
the recess is provided with a drainage hole and an eave arranged above the drainage hole,
the drainage hole is located below an upper surface of the flat portion, and
the eave is at least partially located below the upper surface of the flat portion.

2. The combustion device according to claim 1, wherein the drainage hole and the eave are formed by cutting a part of the recess and bending the part inward.

3. The combustion device according to claim 1, wherein the drainage hole and the eave are formed by cutting a part of the recess and performing inward drawing to the part.

4. The combustion device according to claim 1, wherein
the recess comprises a first plate inclined with respect to the flat portion, and
the drainage hole is defined in the first plate.

5. The combustion device according to claim 4, wherein the eave is connected to an upper portion of a peripheral edge of the drainage hole.

6. The combustion device according to claim 4, wherein the recess further comprises a second plate that is inclined with respect to the flat portion and arranged to face the first plate in a direction along the flat portion.

7. The combustion device according to claim 2, wherein
the recess comprises a first plate inclined with respect to the flat portion,
the drainage hole is defined in the first plate,
the eave is connected to an upper portion of a peripheral edge of the drainage hole, and
the recess further comprises a second plate that is inclined with respect to the flat portion and arranged to face the first plate in a direction along the flat portion.

8. The combustion device according to claim 3, wherein
the recess comprises a first plate inclined with respect to the flat portion,
the drainage hole is defined in the first plate,
the eave is connected to an upper portion of a peripheral edge of the drainage hole, and
the recess further comprises a second plate that is inclined with respect to the flat portion and arranged to face the first plate in a direction along the flat portion.
